(19) United States
(12) Patent Application Publication
(10) Pub. No.: US 2016/0116901 A1
(43) Pub. Date: Apr. 28, 2016

(54) NUMERICAL CONTROL DEVICE

(71) Applicant: FANUC Corporation, Minamitsuru-gun (JP)

(72) Inventors: Kenji TANAKA, Minamitsuru-gun (JP); Kazuhiko MORISAKI, Minamitsuru-gun (JP); Koichi MURATA, Minamitsuru-gun (JP); Masahiko HOSOKAWA, Minamitsuru-gun (JP)

(21) Appl. No.: 14/923,613

(22) Filed: Oct. 27, 2015

(30) Foreign Application Priority Data
Oct. 28, 2014 (JP) 2014-219198

(51) Int. Cl. G05B 19/406

(52) U.S. Cl. CPC G05B 19/406; G05B 2219/33192

(57) ABSTRACT

A numerical control device has function of detecting setting location of a machine to be controlled and restricting usage or function of the machine when the setting location is not a predetermined location. The numerical control device includes a machine operation locking unit, a current location information acquisition unit configured to acquire global IP address to be used when the numerical control device is connected to internet, and generate current location information including information of region, address region of the global IP address allocated thereto, a setting location information storage unit, a location information comparison unit, a machine operation locking release unit.

### BACKGROUND OF THE INVENTION

1. Field of the Invention

The present invention relates to a numerical control device, and more particularly to a numerical control device which detects movement of setting location of the numerical control device using network address.

2. Description of the Related Art

The present invention relates to a numerical control device, and more particularly to a numerical control device which detects movement of setting location of the numerical control device using network address.

Relocation detection system disclosed in Japanese Patent Laid-Open NO. 2008-129706 is known as a prior art for restricting usage of a machining tool by detecting the setting location of the machining tool. The relocation detection system in Japanese Patent Laid-Open NO. 2008-129706 includes a GPS antenna, a current location acquisition unit, a setting location storing unit, a current location comparison unit, a machine start lock unit, and a machine start lock release unit, and is connected to a machining tool.

When usage of the machining tool is restricted in the relocation detection system in Japanese Patent Laid-Open NO. 2008-129706, the current position is acquired using radio wave of a GPS satellite received by a GPS antenna, and the current location comparison unit compares information of permitted setting location where setting of the machine is allowed stored in the setting location storing unit, and information of the current location, determines whether the information of the current location accords with the information of the permitted setting location or not, to output the determination result to the machining start lock unit.

The machining start lock unit, when it is determined that the information of the current location does not accord with the information of the permitted setting location, determines that the machining tool is relocated, and restrict s the start of the machining tool and enables input of the password only. Input of the password is restricted in number, and the machine start lock release unit unlocks the start of the machining tool when correct password is input within a restricted number, while the machine start lock unit stops the start of the machining tool when input times of incorrect password exceeds a restriction number.

Since indoor use of the relocation detection system disclosed in Japanese Patent Laid-Open NO. 2008-129706, as in a place where the radio wave of the GPS scarcely reaches, is impossible, detectable range is severely restricted. A relocation detection system disclosed in Japanese Patent Laid-Open NO. 2013-134550 is known to solve the above problem. The relocation detection system disclosed in Japanese Patent Laid-Open NO. 2013-134550 includes a radio frequency communication antenna, a radio wave state confirmation unit, a base station information acquisition unit, a base station information storing unit, a base station information comparison unit, a machine start lock unit, and a machine start lock release unit, and is connected to a machining tool.

When usage of the machining tool is restricted in the relocation detection system in Japanese Patent Laid-Open NO. 2013-134550, the radio wave state confirmation unit determines whether the communication antenna is in good condition or not to output the determination result to the machine start lock unit, and performs radio communication with the nearest base station to acquire the information of the base station when the radio wave state is in good condition. The base station information storing unit stores information of the designated base station, which is a base station allowed to be used, stored in advance. The base station information comparison unit compares information output from the base station information acquisition unit and information output from the base station information storing unit, and determines whether the information of the using base station accords with the information of the designated base station or not, to output the determination result to the machine start lock unit.

The machine start lock unit restricts the start of the machining tool and enables input of the password when the machine start lock unit determines that the radio wave state of the communication antenna is not in good condition or the using base station does not accord with the information of the designated base station. Since restriction or release of restriction of the start of the machining tool by the password are similar to those in Japanese Patent Laid-Open NO. 2008-129706, the explanation will be omitted here.

FIG. 11 is a schematic flowchart illustrating operation of the relocation detection system described in Japanese Patent Laid-Open NO. 2013-134550.

[Step SD01] Radio wave state of the communication antenna is acquired.
[Step SD02] It is determined whether the radio wave state of the communication antenna acquired in Step SD01 is in good condition or not. The process proceeds to Step SD03 when the radio wave state is in good condition, and proceeds to Step SD11 when the radio wave state is not in good condition.
[Step SD03] Line state of the communication module is acquired.
[Step SD04] It is determined whether the line state of the communication antenna acquired in Step SD03 is in good condition or not. The process proceeds to Step SD05 when the line state is in good condition, and proceeds to Step SD11 when the line state is not in good condition.
[Step SD05] Radio communication with the nearest radio wave base station is performed and base station information of the radio wave base station is acquired.
[Step SD06] The base station information of the using base station acquired in Step SD05 and the base station information of the designated base station which is a radio base station allowed to be used are compared to each other to determine whether these two pieces of information accord with each other or not. The process proceeds to Step 10 when the two pieces of information accord with each other, and proceeds to Step 07 when the two pieces of information do not accord with each other.
[Step SD07] Screen in which only input of password is possible is displayed in the display unit, and the password input by the operator is acquired.
[Step SD08] It is determined whether input times of the password exceeds the predetermined password input restriction number. The process proceeds to Step 11 when the input times exceeds the password input restriction number, and proceeds to Step 09 when the input times does not exceed the password input restriction number
[Step SD09] The password input in Step SD07 is confirmed. The process proceeds to Step SD10 when the password is correct, and returns to Step SD07 when the password is incorrect.
[Step SD10] The machining tool is started.
[Step SD11] Start of the machining tool is stopped.

A machining tool with high accuracy has possibility to be used in army or in terrorism, but the above relocation detection system restricts usage of the machining tool after relation to the specific country or area where restriction is necessary. However, there is a problem that the usage of these machining tools can not be restricted when a machining tool with poor accuracy to which the restriction is unnecessary is imported to be remodeled to a machining tool with high accuracy, or when components comprising the machining tool is imported to manufacture the machining tool with high accuracy, in the specific country or area.

In addition to that, the relocation system in the prior art has the problem below. Since indoor use of the relocation detection system using GPS function disclosed in Japanese Patent Laid-Open NO. 2008-129706, as in a place where the radio wave of the GPS scarcely reaches, is impossible as mentioned above, detectable range is severely restricted.

The relocation detection system using the information of the surrounding radio wave base station described in Japanese Patent Laid-Open NO. 2013-134550 solves the problem of the relocation detection system in Japanese Patent Laid-Open NO. 2008-129706, but since the method depends on the radio wave state, the machine can not be started when the radio wave state is in bad condition, and the machine stops when the radio wave state is changed to be in bad condition even if the machine can be started when the radio wave state is in good condition. For this reason, there is a problem that the user needs to communicate with the manufacturer to acquire the password to release the start restriction or the like every time when the radio wave status is brought to be in bad condition, increasing operation cost.

### SUMMARY OF THE INVENTION

In view of the above-described problems in the prior art techniques, a purpose of the present invention is to provide a numerical control device which enables to detect relocation of the numerical control device without using dedicated software or hardware.

A numerical control device according to the present invention is the numerical control device having function of detecting setting location of a machine to be controlled and restricting usage or function of the machine when the setting location is not a predetermined location, the numerical control device including a machine operation locking unit configured to perform locking control for restricting the usage of the machine, a current location information acquisition unit configured to acquire global IP address to be used when the numerical control device is connected to internet, and generate current location information including information of region, address region of the global IP address allocated thereto, a setting location information storage unit configured to store a setting location information including information of region, setting of the machine is allowed therein, a location information comparison unit configured to determine whether information of region included in the current location information and information of region included in the setting location information accord with each other or not, a machine operation locking release unit configured to output command to release the locking control to the machine operation locking unit based on determination result by the location information comparison unit.

The numerical control device may further include a usage option storing unit configured to store information of optional function to be used in the machine, and an option management unit configured to restrict optional function not allowed to be used in the machine based on the determination result by the location information comparison unit and the information of optional function stored in the usage option storing unit, wherein the machine operation locking release unit is configured to output the command to release the locking control to the machine operation locking unit based on the determination result by the location information comparison unit and determination by the option management unit.

The numerical control device ma further includes a software version acquisition unit configured to acquire version number of software for controlling the numerical control device, a software version storing unit configured to version information including version number of software allowed to use in the numerical control device, and a software version comparison unit configured to determine whether the version number of software acquired by the software version acquisition unit and the version number of software included in the version information stored by the software version storing unit accord with each other or not, wherein the machine operation locking release unit is configured to output the command to release the locking control to the machine operation locking unit based on the determination result by the location information comparison unit and determination by the software version comparison unit.

The present invention, with the above configuration, is capable of detecting relocation when the device is in state where the device can be connected to the internet, and can restrict addition and usage of function which enables machining with high accuracy or services for upgrading the software which controls the numerical control device, after the numerical control device is moved to the improper country or area.

With the configuration, usage of the machining tool with high accuracy can be restricted manufactured or remodeled in the improper country or area. In addition to that, software or hardware dedicated to communication with GPS or the radio wave base station is unnecessary since the numerical control device detects the relocation, and remodeling for avoiding the relocation to be detected, and furthermore, the initial cost of the machining tool can be decreased.

### BRIEF DESCRIPTION OF THE DRAWINGS

The above-described object, the other object, and the feature of the invention will be proved from the description of embodiments below with reference to the accompanying drawings. In these drawings:

FIG. 1 is a schematic diagram of function for detecting a setting location to restrict machine operation according to some embodiments of the present invention.

FIG. 2 is a schematic block diagram of a numerical control device according to the first embodiment of the present invention.

FIG. 3 is a functional block diagram of a numerical control device according to the first embodiment of the present invention.

FIG. 4 is a flowchart of a process to be executed in a numerical control device according to the first embodiment of the present invention.

FIG. 5 is a schematic block diagram of a numerical control device according to the second embodiment of the present invention.

FIG. 6 is a functional block diagram of a numerical control device according to the second embodiment of the present invention.

FIG. 7 is a flowchart of a process to be executed in a numerical control device according to the second embodiment of the present invention.

FIG. 8 is a schematic block diagram of a numerical control device according to the third embodiment of the present invention.

FIG. 9 is a functional block diagram of a numerical control device according to the third embodiment of the present invention.

FIG. 10 is a flowchart of a process to be executed in a numerical control device according to the third embodiment of the present invention.

FIG. 11 is a flowchart of a process to detect a setting location to restrict machine operation.

### DETAILED DESCRIPTION OF THE PREFERRED EMBODIMENTS

Relocation detection method according to a few embodiments in the present invention will be outlined first.

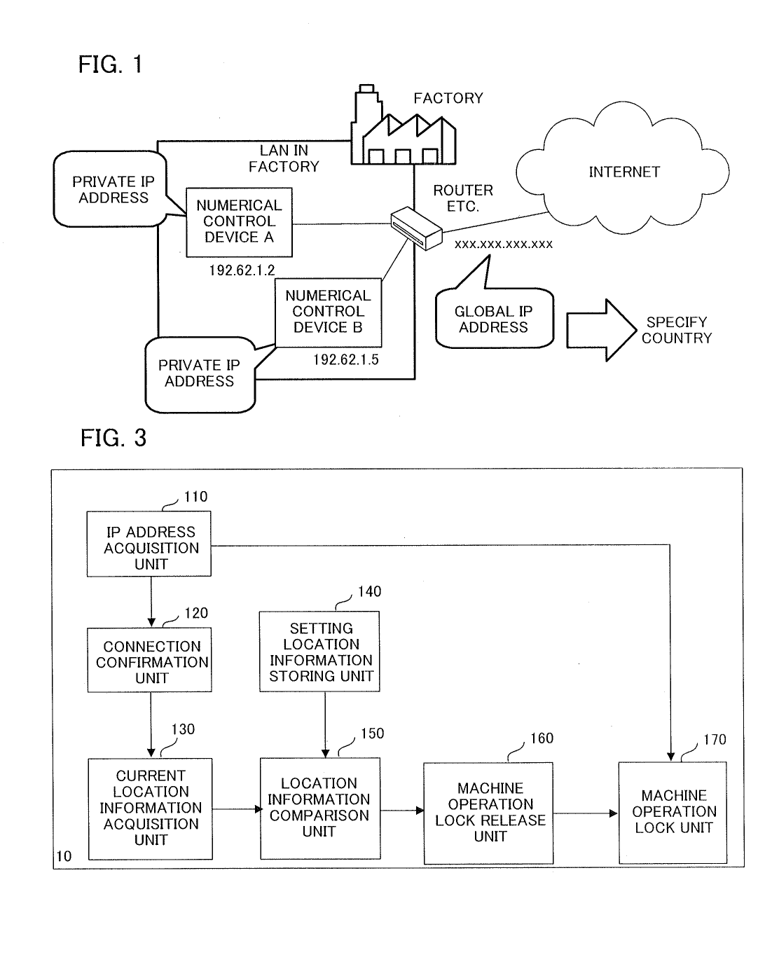

In the present embodiment, a numerical control device using global IP address as location information will be provided. As shown in FIG. 1, private IP address is set in each numerical control device, and the numerical control device is connected to a LAN in the factory. A network conversion device such as a router having NAT function or the like converts the private IP address to the global IP address to enable the numerical control device to be connected to the internet.

Since the global IP address generally uses unique range of address region dependent on country or area, the country or the area where the device using the global IP address is set can be specified by investigating in which range of the address region the global IP address is contained. In the present embodiment, the country or the area of the factory in which the numerical control device is set is determined to detect relocation of the numerical control device, making use of the above system.

### First Embodiment

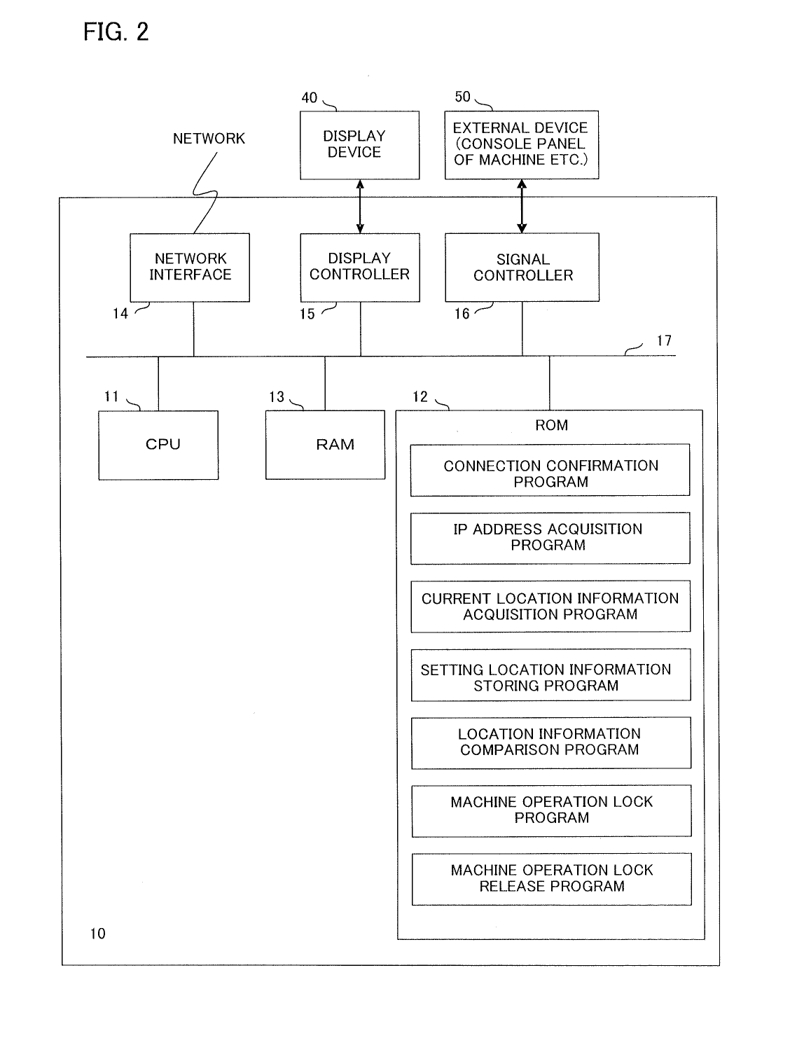

FIG. 2 is a schematic block diagram of a numerical control device according to an embodiment of the present invention. The numerical control device 10 includes a CPU 11, a ROM 12, a RAM 13, a network interface 14, a display control device 15, a signal control device 16.

The CPU 11 is a processor for controlling entire numerical control device 10.

The ROM 12 stores system program to be used for controlling entire numerical control device 10. The system program includes program to implement each function which the numerical control device 10 in the present embodiment should have. The CPU 11 reads via a bus and executes the program such that the numerical control device 10 in the present embodiment functions as each function unit.

The RAM stores temporary calculation data, display data, and various kinds of data input by the operator, and each function unit uses the RAM.

The network interface 14 is connected with the LAN in the factory via a network cable, and configured to communicate with a device connected to the LAN in the factory and a device connected to the internet, which is connected through a router having NAT function or the like.

The display controller 15 is connected with a display unit 40 such as a display, generates image to show information in the numerical control device 10 to the operator or the like, and display on the display unit 40.

The signal control device enables connection between the numerical control device 10 and the external device 50 such as a console panel of the machine.

FIG. 3 is a functional block diagram of the numerical control device according to the present embodiment of the present invention. The numerical control device 10 in the present embodiment executes each system program stored in the ROM 12, to function as an IP address acquisition unit 110, a connection confirmation unit 120, a current location information acquisition unit 130, a setting location information storing unit 140, a location information comparison unit 150, a machine operation lock release unit 160, and a machine operation lock unit 170.

The IP address acquisition unit 110 acquires information of the IP address stored in the numerical control device 10 in advance (what is called, network configuration), determines whether network configuration by the IP address information is effective or not, and output the result to the machine operation lock unit 170 when the network configuration is not effective to restrict the numerical control device to enable only resetting of the information of the IP address and to prompt the operator to reset the information of the IP address. The IP address acquisition unit 110 outputs the information of the IP address to the connection confirmation unit 120 when the network configuration is effective.

It is determined whether the information of the IP address is effective or not based on, not only if right value is set according to the IP address configuration, but also whether the fundamental configuration necessary for implementing the function of the present invention is set, including if fundamental configuration to communicate with the device in the LAN is set, if gateway for connecting to the internet is set, or the like.

When the connection confirmation unit 120 receives the information of the IP address from the IP address acquisition unit 110, the connection confirmation unit 120 confirms whether the numerical control device 10 is connected to the internet or not based on the information of the IP address. The connection confirmation unit 120 shows message prompting connection to internet when the numerical control device 10 is not connected to the internet and outputs the information of the IP address input from the IP address acquisition unit 110 to the current location information acquisition unit when the connection of the numerical control device 10 to the internet is confirmed. It is determined whether the numerical control device 10 is connected to the internet or not by confirming whether the manufacturer of the numerical control device 10 or the like can perform connection via the internet to a server or the like set in the internet using ICMP (Internet Control Message Protocol) or the like.

The current location information acquisition unit 130 searches the network conversion device such as a NAT sever, a NATP server, connected to the LAN in the factory, acquires global IP address from the network conversion device based on the IP address received from the connection confirmation unit 120, acquires information of country name or country code specified by the global IP address based on the acquired global IP address, and output the information as current location information to the location information comparison unit 150. The process to acquire the information of the country name or the country code based on the global IP address is performed by preparing and referring to corresponding table of the global IP address and the country name or the country code on the ROM 12 in advance, or by using service in which country name is searched based on the IP address provided on the internet.

The setting location information storing unit 140 stores and manages information of the country name or the country code for permitting the setting of the machine in advance, and output the information as the setting location information to the location information comparison unit 150.

The location information comparison unit 150 determines whether the current location information input from the current location information acquisition unit 130 accords with the setting location information input from the setting location information storing unit 140 or not, and output the determination result to the machine operation lock release unit 160.

The machine operation lock release unit 160 commands to release the restriction of machine operation to the machine operation lock unit only when the current location information accords with the setting location information.

The machine operation lock unit 170 has function for locking machine operation when the numerical control device 10 is started with the machine, and restricting the machine operation. At this time, the machine operation lock unit 170 restricts the numerical control device 10 not to receive operation or signal from the external, and keep the state until the machine operation lock unit 170 receives machine operation restriction release command from the machine operation lock release unit 160.

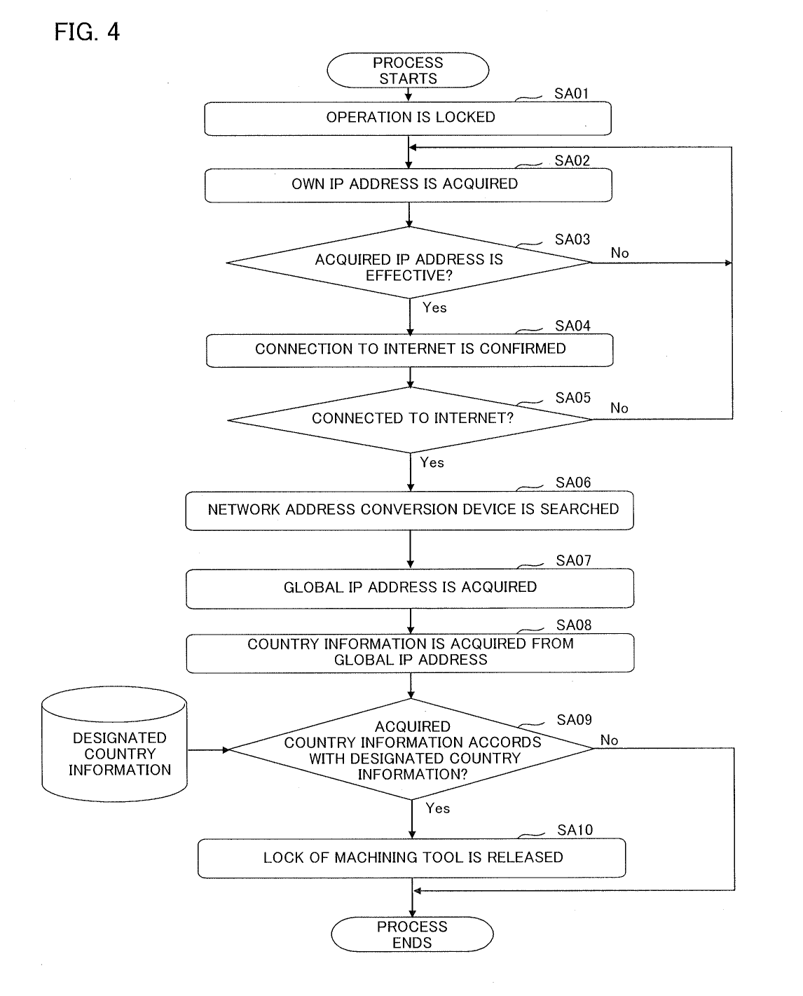

FIG. 4 is a flowchart illustrating the flow of the process to be executed in the numerical control device according to the present embodiment.

[Step SA01] Machine operation is locked and the numerical control device 10 is restricted not to receive operation or signal from the external at the start.
[Step SA02] Information of the IP address stored in the numerical control device 10 is acquired.
[Step SA03] It is determined whether the network configuration by the information of the IP address acquired in Step SA02 is effective or not. The process proceeds to Step SA04 when the network configuration is effective. Setting of the information of the IP address is prompted by displaying on the display device 40 to receive the setting of the IP address and the process returns to Step SA02 when the network configuration is not effective.
[Step SA04] Confirmation process of the connection to the internet is executed.
[Step SA05] It is determined whether the connection to the internet is implemented or not in Step SA04. The process proceeds to Step SA06 when the connection to the internet is implemented. Confirmation of setting of the internet connection, in addition to the setting of the information of the IP address, is prompted by displaying on the display unit 40, to receive the setting of the IP address, and the process returns to Step SA02 when the connection to the internet is not implemented.
[Step SA06] The network address conversion device connected to the LAN set in the factory is searched.
[Step SA07] Referring to the network address conversion device, searched in Step SA06, the global IP address to be used for access to the internet is acquired.
[Step SA08] Country information of the country where the global IP address is used is acquired based on the global IP address required in Step SA07.
[Step SA09] The country information acquired in Step SA08 (corresponding to the current location information) and the country information stored in the setting location information storing unit 140 (corresponding to the setting location information) are compared to each other to determine whether these two pieces of country information accord with each other. The process proceeds to Step SA10 when these two pieces of country information accord with each other. The process ends without releasing the lock of the machine and the restriction of the numerical control device 10 when these two pieces of country information do not accord with each other.
[Step SA10] The lock of the machining tool is released and the restriction of the numerical control device 10 is released.

As described above, since the numerical control device 10 according to the present information can detect the setting location of the numerical control device 10 based on the global IP address and lock the machining tool and the numerical control device 10 so as not to be used when the setting location is out of the designated countries, a case can be prevented in which the numerical control device 10 is brought to the improper country or area to be used.

### Second Embodiment

In the first embodiment, the numerical control device having locking function to prevent usage when the device is set in countries other than the designated countries. In the present embodiment, a numerical control device having function of, not disabling the usage of the machining tool or the numerical control device, but restricting usage of partial function with high accuracy.

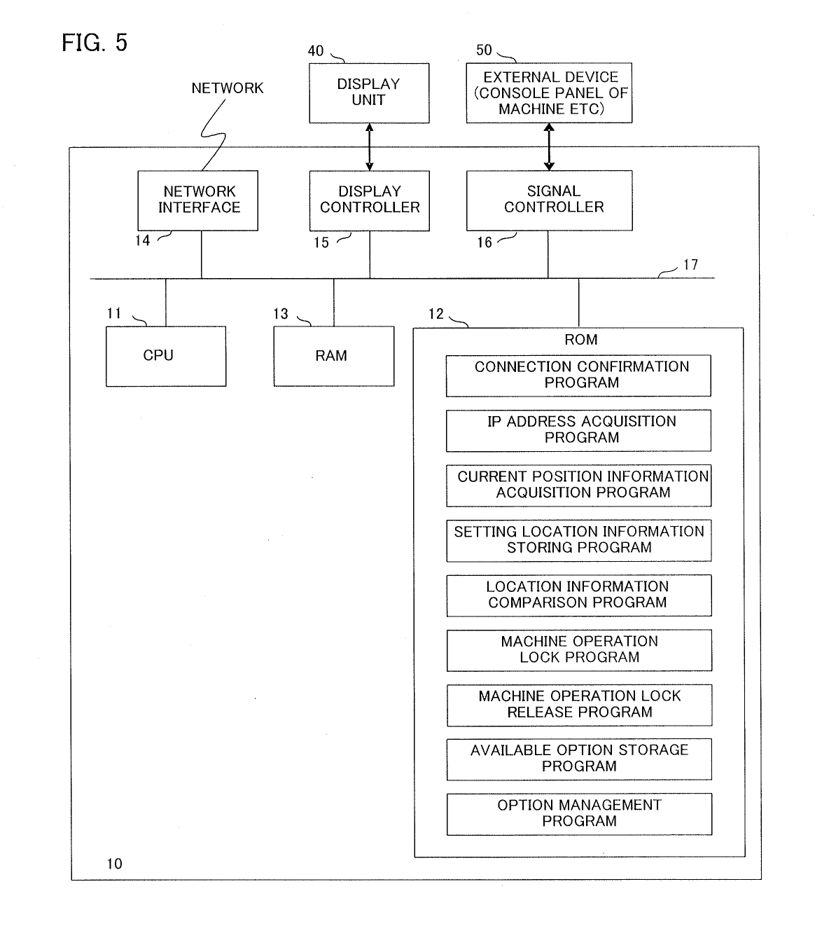

FIG. 5 is a schematic block diagram of the numerical control device according to the present embodiment. The numerical control device 10 in the present embodiment is different from the numerical control device 10 in the first embodiment in that available option storage program and option management program are added to the system program stored in the ROM 12.

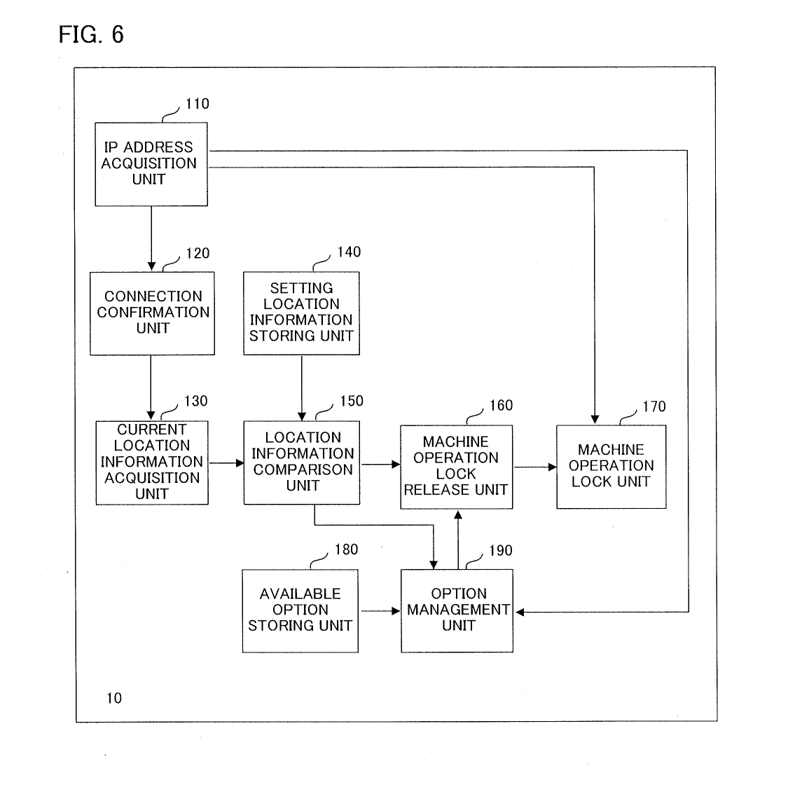

FIG. 6 is a functional block diagram of the numerical control device according to the present embodiment.

The connection confirmation unit 120, the current location information acquisition unit 130, the setting, location information storing unit 140, the location information comparison unit 150 in the present embodiment are same to those in the first embodiment, so the explanation is omitted here.

The IP address acquisition program 110 in the present embodiment acquires the information of the IP address set in the numerical control device 10 in advance, determines whether the network configuration by the information of the IP address is effective or not. The IP address acquisition program 110 outputs the result to the machine operation lock unit 170 when the network configuration by the information of the IP address is not effective, and restrict the numerical control device to enable only two operation of resetting of the information of the IP address and skipping of the connection to the internet. When the operator skips the connection to the internet, the information of the skipping is output to the option management unit 190 as the skip information.

Available option storing unit 180 stores information of individual functions available in the machine in advance, and outputs the information as the available option information to the option management unit 190. The information of each individual function included the available option information is stored in association with availability information showing the availability of the function when the internet connection is skipped or the current location information does not accords with the setting location information.

The option management unit 190 determines whether each function is available or not using the available option information input from the available option storing unit 180 based on the skip information input from the IP address acquisition unit 110 and the comparison result input from the location information comparison unit 150, restricts the numerical control not to be used for high accuracy function when the internet connection is skipped or when the current location information does not accord with the setting location information, and outputs the result to the machine operation lock release unit 160.

The machine operation lock release unit 160 displays message that the high accuracy function is restricted on the display unit 40 only when usage of the high accuracy function is not available, and releases the lock of the machine operation.

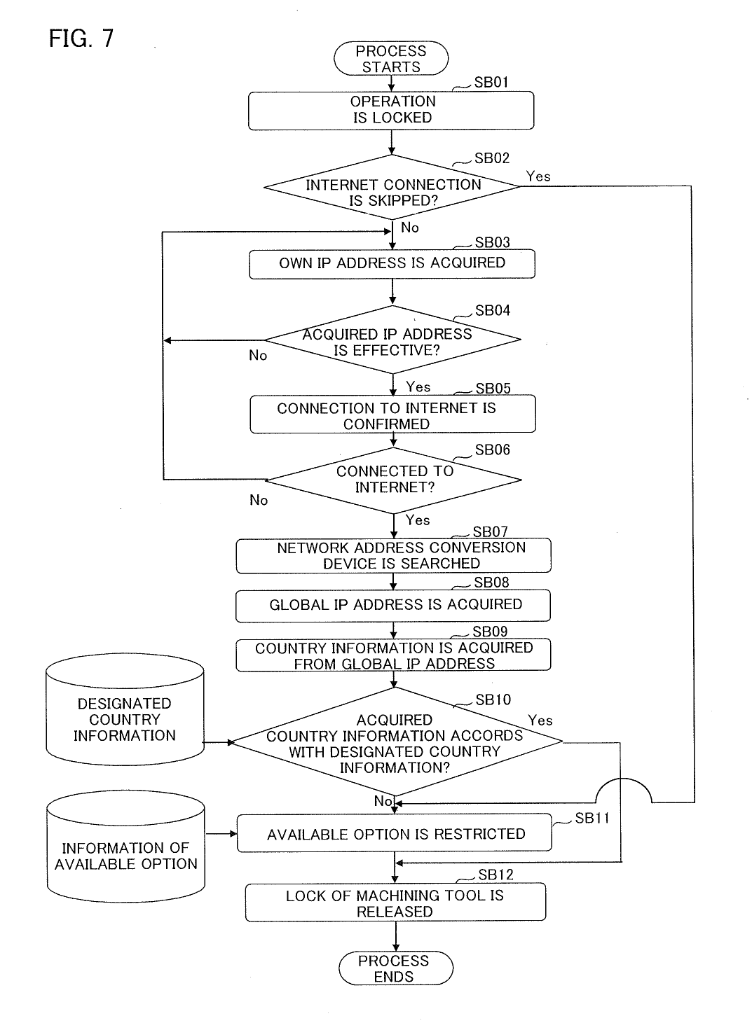

FIG. 7 is a flowchart illustrating the flow of the process to be executed in the numerical control device according to the present embodiment.

[Step SB01] Machine operation is locked and the numerical control device 10 is restricted not to receive operation or signal from the external at the start.
[Step SB02] It is determined whether the operator skipped the internet connection or not. The process proceeds to Step SB11 when the internet connection is skipped, and the process proceeds to Step SB03 when the internet connection is not skipped.
[Step SB03] Information of the IP address stored in the numerical control device 10 is acquired.
[Step SB04] It is determined whether the network configuration by the information of the IP address acquired in Step SB03 is effective or not. The process proceeds to Step SB05 when the network configuration is effective. Setting of the information of the IP address is prompted by displaying on the display device 40 to receive the setting of the IP address and the process returns to Step SB03 when the network configuration is not effective.
[Step SB05] Confirmation process of the connection to the internet is executed.
[Step SB06] It is determined whether the connection to the internet is implemented or not in Step SB05. The process proceeds to Step SB07 when the connection to the internet is implemented. Confirmation of setting of the internet connection, in addition to the setting of the information of the IP address, is prompted by displaying on the display unit 40, to receive the setting of the IP address, and the process returns to Step SB03 when the connection to the internet is not implemented.
[Step SB07] The network address conversion device connected to the LAN set in the factory is searched.
[Step SB08] Referring to the network address conversion device, searched in Step SB07, the global IP address to be used for access to the internet is acquired.
[Step SB09] Country information of the country where the global. IP address is used is acquired based on the global IP address required in Step SB08.
[Step SB10] The country information acquired in Step SB09 (corresponding to the current location information) and the country information stored in the setting location information storing unit 140 (corresponding to the setting location information) are compared to each other to determine whether these two pieces of country information accord with each other. The process proceeds to Step SB12 when these two pieces of country information accord with each other, and proceeds to Step SB11 when these two pieces of country information do not accord with each other.
[Step SB11] Usage of functions including high accuracy function is restricted.
[Step SB12] The lock of the machining tool is released and the restriction of the numerical control device 10 is released except for the function restricted in Step SB11.

As mentioned above, since the numerical control device 10 itself can restrict the function necessary for machining in the present embodiment, usage of the high accuracy function in the improper country or area can be restricted.

### Third Embodiment

In the first embodiment, the numerical control device having locking function to prevent usage when the device is set in countries other than the designated countries. In the present embodiment, a numerical control device having usage restriction function according to version number of software installed in the numerical control device.

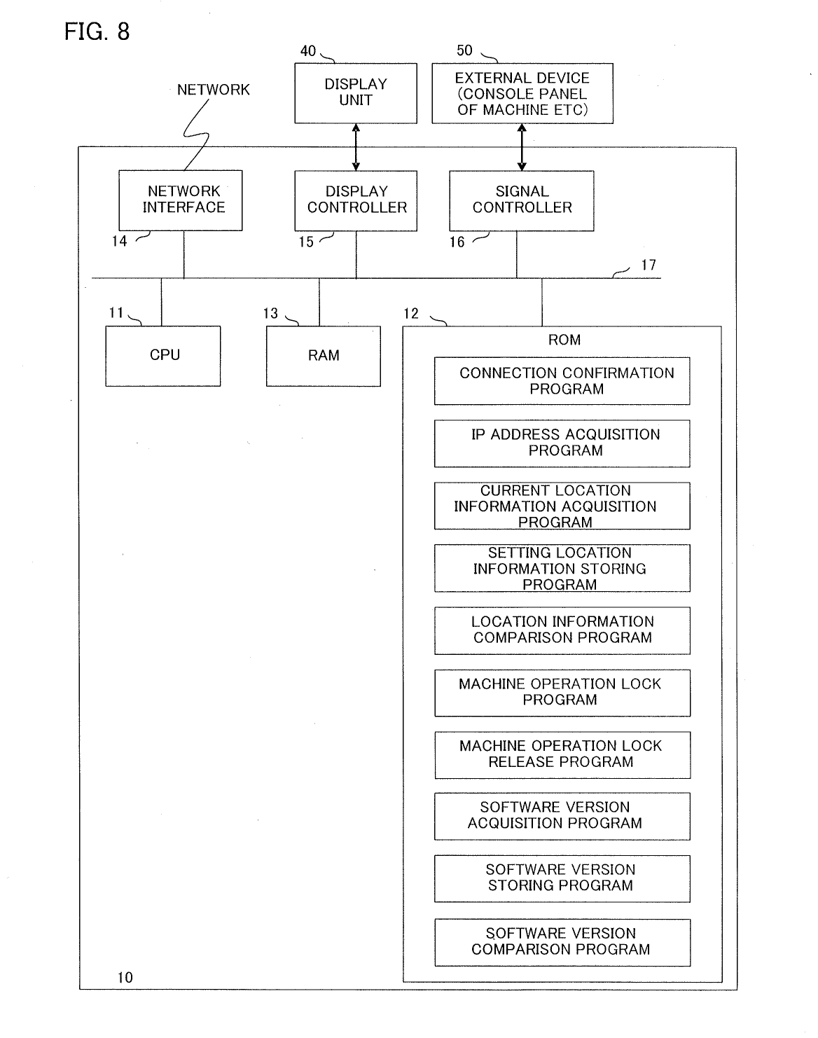

FIG. 8 is a schematic block diagram of the numerical control device according to the present embodiment. The numerical control device 10 in the present embodiment is different from the numerical control device 10 in the first embodiment in that software version acquisition program, software version storing program, and software version comparison program are added to the system program stored in the ROM 12.

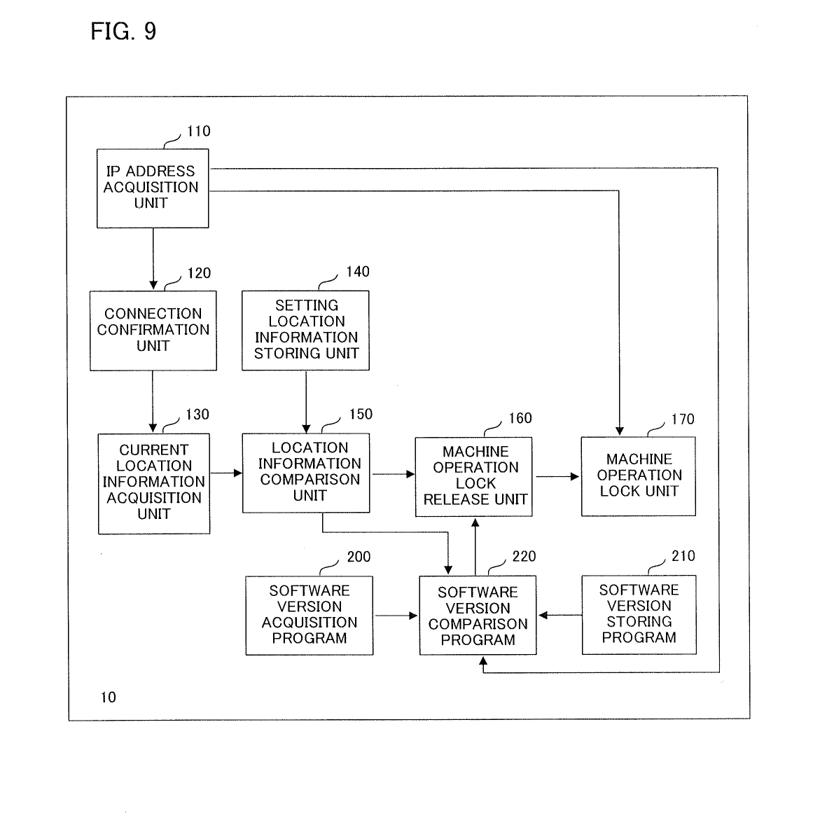

FIG. 9 is a functional block diagram of the numerical control device according to the present embodiment.

The IP address acquisition unit 110, the connection confirmation unit 120, the current location information acquisition unit 130, the setting location information storing unit 140, the location information comparison unit 150 in the present embodiment are same to those in the second embodiment, so the explanation is omitted here.

A software version acquisition program 200 acquires version number of the software controlling the numerical control device 10 and outputs the information as the using version information to a software version comparison unit 220.

A software version storing unit 210 stores and manages the version number of the software permitted to be used in advance, and outputs the information as the permitted version information to the software version comparison unit 220. It should be noted that, the version information stored in the software version storing unit 210 permitted to be used may be configured to be written from a server connected when the software is updated.

The software version comparison unit 220 determines whether the using version information accords with the permitted version information only when it is determined that the current location information does not accord with the setting location information, and outputs the determination result to the machine operation lock release unit 160.

The machine operation lock release unit 160 releases the restriction of the machine operation when the current location information accords with the setting location information or when the using version information accords with the permitted version information.

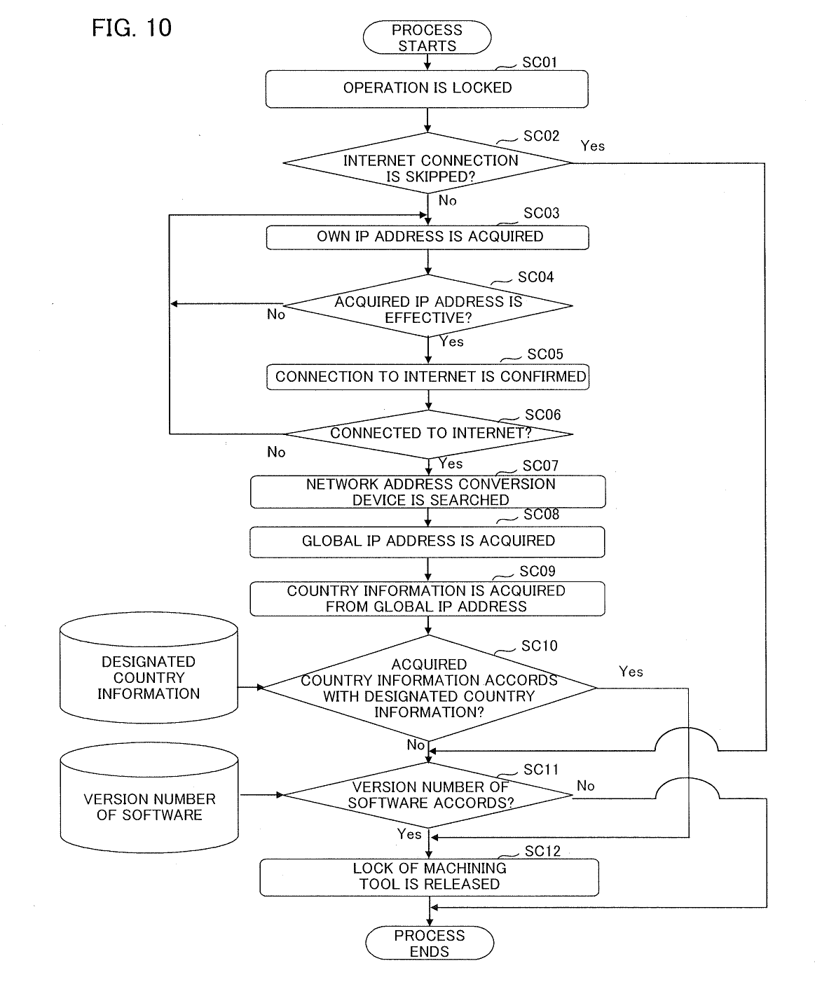

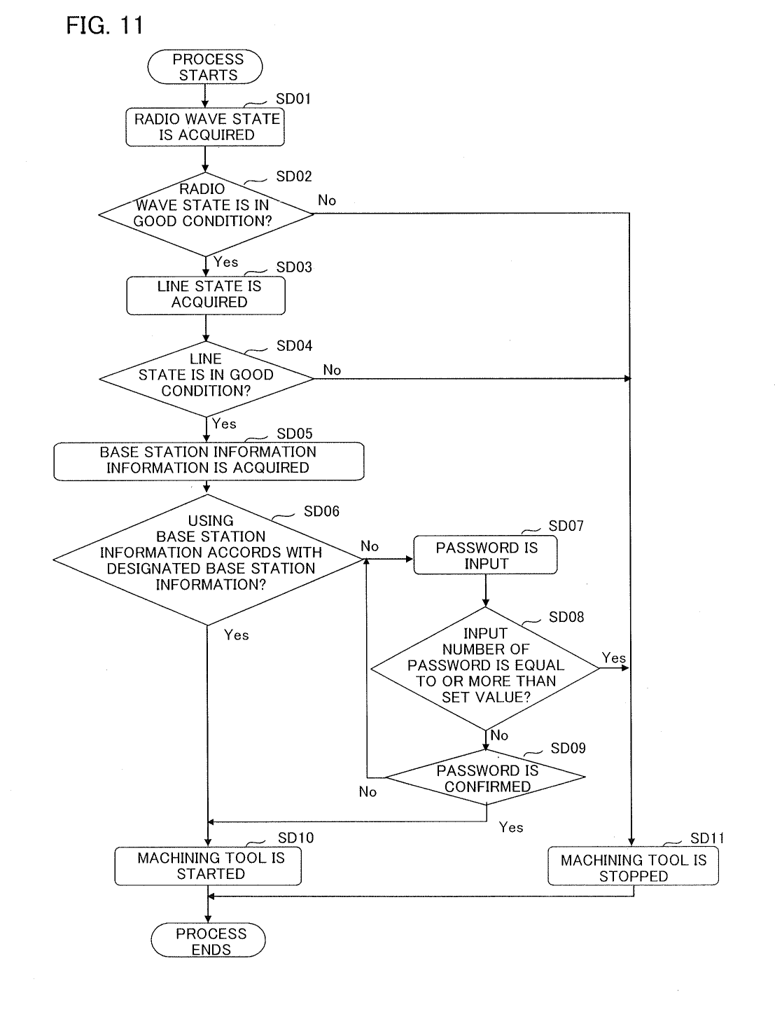

FIG. 10 is a flowchart illustrating the flow of the process to be executed in the numerical control device according to the present embodiment.

[Step SC01] Machine operation is locked and the numerical control device 10 is restricted not to receive operation or signal from the external at the start.
[Step SC02] It is determined whether the operator skipped the internet connection or not. The process proceeds to Step SC11 when the internet connection is skipped, and the process proceeds to Step SC03 when the internet connection is not skipped.
[Step SC03] Information of the IP address stored in the numerical control device 10 is acquired.
[Step SC04] It is determined whether the network configuration by the information of the IP address acquired in Step SC03 is effective or not. The process proceeds to Step SC05 when the network configuration is effective. Setting of the information of the IP address is prompted by displaying on the display device 40 to receive the setting of the IP address and the process returns to Step SC03 when the network configuration is not effective.
[Step SC05] Confirmation process of the connection to the internet is executed.
[Step SC06] It is determined whether the connection to the internet is implemented or not in Step SC05. The process proceeds to Step SC07 when the connection to the internet is implemented. Confirmation of setting of the internet connection, in addition to the setting of the information of the IP address, is prompted by displaying on the display unit 40, to receive the setting of the IP address, and the process returns to Step SC03 when the connection to the internet is not implemented.
[Step SC07] The network address conversion device connected to the LAN set in the factory is searched.
[Step SC08] Referring to the network address conversion device, searched in Step SC07, the global IP address to be used for access to the internet is acquired.
[Step SC09] Country information of the country where the global IP address is used is acquired based on the global IP address required in Step SC08.
[Step SC10] The country information acquired in Step SC09 (corresponding to the current location information) and the country information stored in the setting location information storing unit 140 (corresponding to the setting location information) are compared to each other to determine whether these two pieces of country information accord with each other. The process proceeds to Step SC12 when these two pieces of country information accord with each other, and proceeds to Step SC11 when these two pieces of country information do not accord with each other.
[Step SC11] It is determined whether the software version installed in the numerical control device accords with the software version stored in the software version storing unit 210 or not. The process proceeds to Step SC12 when the two versions accord with each other. The process ends without releasing the lock of the machine and the restriction of the numerical control device 10 when the two versions do not accord with each other.
[Step SC12] The lock of the machining tool is released and the restriction of the numerical control device 10 is released.

As described above, since the numerical control device 10 according to the present information can restrict the software version controlling the numerical control device 10 according to the current location, usage of the latest numerical control device 10 or the newly added function in the improper country or area can be restricted.

1. A numerical control device having function of detecting setting location of a machine to be controlled and restricting usage or function of the machine when the setting location is not a predetermined location, the numerical control device comprising:
a machine operation locking unit configured to perform locking control for restricting the usage of the machine;
a current location information acquisition unit configured to acquire global IP address to be used when the numerical control device is connected to Internet, and generate current location information including information of region, address region of the global IP address allocated thereto;
a setting location information storage unit configured to store a setting location information including information of region, setting of the machine is allowed therein;
a location information comparison unit configured to determine whether information of region included in the current location information and information of region included in the setting location information accord with each other or not;
a machine operation locking release unit configured to output command to release the locking control to the machine operation locking unit based on determination result by the location information comparison unit.

2. A numerical control device according to claim 1, further comprising:
a usage option storing unit configured to store information of optional function to be used in the machine; and
an option management unit configured to restrict optional function not allowed to be used in the machine based on the determination result by the location information comparison unit and the information of optional function stored in the usage option storing unit; wherein
the machine operation locking release unit is configured to output the command to release the locking control to the machine operation locking unit based on the determination result by the location information comparison unit and determination by the option management unit.

3. A numerical control device according to claim 1, further comprising:
a software version acquisition unit configured to acquire version number of software for controlling the numerical control device;
a software version storing unit configured to version information including version number of software allowed to use in the numerical control device; and
a software version comparison unit configured to determine whether the version number of software acquired by the software version acquisition unit and the version number of software included in the version information stored by the software version storing unit accord with each other or not; wherein
the machine operation locking release unit is configured to output the command to release the locking control to the machine operation locking unit based on the determination result by the location information comparison unit and determination by the software version comparison unit.
